(19) United States
(12) Patent Application Publication
(10) Pub. No.: US 2008/0084576 A1
(43) Pub. Date: Apr. 10, 2008

(54) System and method to remotely control the front panel of a multi-function peripheral from an embedded web server

(76) Inventor: Nehal Dantwala, Newport Beach, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/545,997

(22) Filed: Oct. 10, 2006

(51) Int. Cl. G06F 3/12

(52) U.S. Cl. 358/1.15

(57) ABSTRACT

A system and method for remotely controlling a MFP are disclosed. In one aspect, the system comprises a MFP having a front panel and an embedded web server. The system also comprises a remote user interface, which is remotely connected to the MFP by the embedded web server and permits modifications to the MFP via front panel commands.

### RELATED APPLICATIONS

This application is related to U.S. Application No. (Attorney Docket No: SAMINF.033A), filed on the same day herewith and titled “SYSTEM AND METHOD TO REMOTELY ACCESS MULTI-FUNCTION PERIPHERAL (MFP) WORKFLOWS,” which is hereby incorporated by reference.

### BACKGROUND OF THE INVENTION

1. Field of the Invention

The invention relates to a multi-function peripheral (MFP). More particularly, the invention relates to remote access and control of a MFP.

2. Description of the Related Technology

Modern office environments provide computer networks that provide access to shared peripherals such as multi-function peripherals (MFPs). A network manager is generally remote from each shared device and needs to be able to get status, reconfigure and maintain many devices on the network. There are certain functions available on the front panel of the MFP that the manager needs to view, in which case there can be inconvenience in accessibility due to distance. Currently, devices such as MFPs provide a remote view of the front panel, or control panel, through an embedded web server. However, the remote view provided only reflects a static, or inactive, view of the front panel such as a screen shot of the front panel as seen by the user at the device. The remote user cannot use the functions provided by the front panel, neither can the remote user traverse the different menus provided. Therefore, it is desirable to provide a remote operation capability in these devices and give a user the ability to remotely control the front panel.

### SUMMARY OF CERTAIN INVENTIVE ASPECTS

The system, method, and devices of the invention each have several aspects, no single one of which is solely responsible for its desirable attributes. Without limiting the scope of this invention, its more prominent features will now be briefly discussed.

In one aspect, there is a system for remotely controlling a multi-function peripheral (MFP). The system comprises a MFP having a front panel and an embedded web server, and a remote user interface. The remote user interface is remotely connected to the MFP by the embedded web server and permits modifications to the MFP via front panel commands.

In another aspect, there is a method of remotely controlling a multi-function peripheral (MFP) having a front panel. The method comprises remotely logging onto the MFP through a Uniform Resource Locator (URL), traversing the front panel of the MFP through the URL, and actively selecting different functions of the MFP. The functions are associated with the front panel controls of the MFP.

In another aspect, there is a multi-function peripheral (MFP) containing an embedded web server. The embedded web server establishes a connection with a remote web server, providing simultaneous functionality of front panel controls of the device through both input locations.

In another aspect, there is a multi-function peripheral (MFP) for transmitting a signal to a remote location. The MFP comprises means for remotely logging onto the MFP, means for traversing the front panel of the MFP from the remote location, and means for actively selecting different functions of the MFP from the remote location.

In another aspect, there is a multi-function device (MFP) having a front panel and capable of transmitting and receiving signals to and from a remote location via the World Wide Web. The MFP comprises means for remotely logging onto the MFP through a Uniform Resource Locator (URL), means for traversing the front panel of the device through a URL from a remote location, and means for actively selecting different functions of the MFP from a remote location, wherein the functions are associated with the front panel controls.

### BRIEF DESCRIPTION OF THE DRAWINGS

FIG. 1 is an overview illustrating one embodiment of a system for remotely accessing the front panel of a MFP.

FIG. 2 is a flowchart of one embodiment of a method of remotely controlling the front panel of a MFP.

FIG. 3A illustrates exemplary views of the front panel of a MFP as seen by the front panel user.

FIG. 3B illustrates exemplary views of the front panel of a MFP as seen by the remote front panel user.

FIG. 4A is a flowchart of one exemplary method of remotely modifying the contrast of a MFP.

FIG. 4B illustrates a series of exemplary screen shots as seen through the contrast modification in FIG. 4A.

### DETAILED DESCRIPTION OF CERTAIN INVENTIVE EMBODIMENTS

Various aspects and features of the invention will become more fully apparent from the following description and appended claims taken in conjunction with the foregoing drawings. In the drawings, like reference numerals indicate identical or functionally similar elements. In the following description, specific details are given to provide a thorough understanding of the disclosed methods and apparatus. However, it will be understood by one of ordinary skill in the technology that the disclosed systems and methods may be practiced without these specific details. For example, electrical components may be shown in block diagrams in order not to obscure certain aspects in unnecessary detail. In other instances, such components, other structures and techniques may be shown in detail to further explain certain aspects.

It is also noted that certain aspects may be described as a process, which is depicted as a flowchart, a flow diagram, a structure diagram, or a block diagram. Although a flowchart may describe the operations as a sequential process, many of the operations may be performed in parallel or concurrently and the process may be repeated. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

The purpose of certain embodiments as will be described below is to provide a remote operation capability in devices such as a multi-function peripheral (MFP) and give a user the ability to remotely access the front panel. The MFP may include an embedded web server connected to a remote user interface via a network. The remote user interface interacts with the embedded web server to provide a remote control panel (also referred to as “remote front panel”), which may be, for example, an active web page in a web browser. By interacting with the remote control panel, the user may be able to traverse the menus of the front panel and make a selection to cause the MFP to perform the corresponding operation, as if one is operating the front panel at the device. Changes made by the user via the remote control panel will be reflected by the device and the front panel.

These embodiments may be applicable to various applications. For example, when new features are added into the front panel of a device, the customer is unaware of how to use them. The remote control panel allows demonstrating these new features remotely. When the device breaks down or needs troubleshooting, a service technician may be able to access the device remotely for diagnosis. Further, an administrator now has the option to monitor the device or change the configuration of the device from a remote location. Such a capability benefits remote diagnostics, remote support, and remote monitoring and configuration.

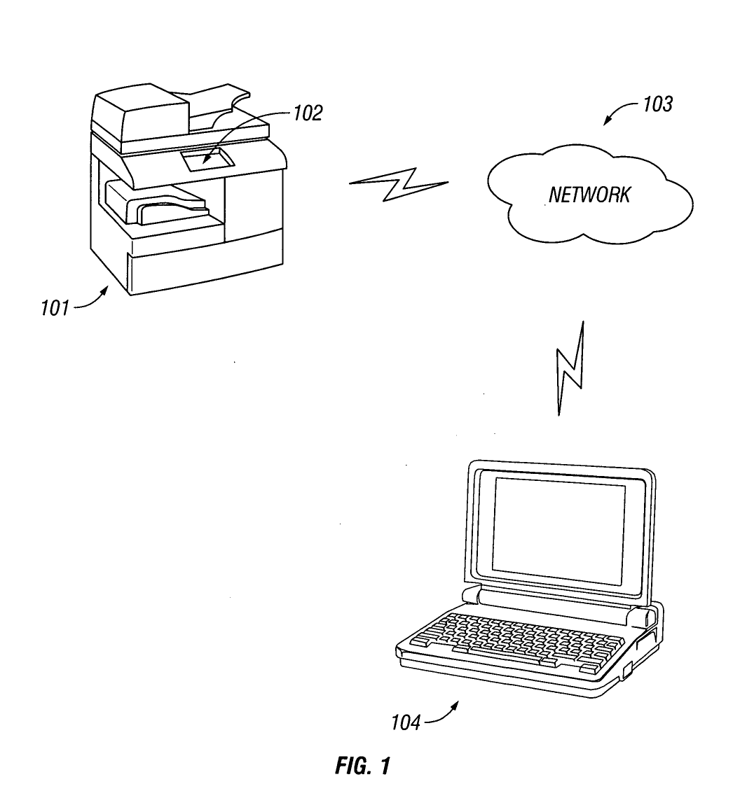

FIG. 1 is an overview illustrating one embodiment of a system for remotely accessing the front panel of a MFP. In various embodiments, a MFP refers to an equipment connectable to a personal computer (PC) or network that handles two or more of the following functions: printing, emailing, copying or faxing. It is also called a multi-function product, a multi-function printer, a multi-function device, an All-in-One device, etc.

A front panel 102 is included in the MFP 101. A front panel may be included in various devices, like a MFP, to provide a user interface to control and operate such a device. Via the front panel, a user may, for example, change and save settings at the device and access other functions provided by the device. Typically, a front panel has a menu interface. The user may look at a menu, click to select one of the items on display, and go to the next screen associated with the selected item. Though a MFP is used as an example for illustration, the embodiments are applicable to any devices having a front panel such as a printer, facsimile, scanner, or copy machine.

A remote user interface (also referred to as “terminal”) 104 is connected to the MFP 101 via a network 103. The network 103 may be wired or wireless. The network 103 may be a local area network (LAN), wide area network (WAN), or the Internet, for example. The remote user interface 104 may be any suitable device that provides a user interface and supports a data communication network connection, such as a personal computer or a personal digital assistant.

In the exemplary embodiment, the remote user interface 104 is connected to an embedded web server of the MFP 101. An embedded web server generally refers to a web server software embedded within a hardware device such as a print server. An embedded web server is widely used in a myriad of devices, because it allows access to the software via any Web browser, typically for configuring the device or obtaining reports.

The connection may be established, for example, when a user types in the IP address of the MFP 101 in a web browser. Once connected, the embedded web server causes a remote control panel to be displayed on the remote user interface 104 in, for example, a web browser. The remote control panel may have substantially the same functionality, and perhaps the same appearance, as the front panel 102. A user may be able to make selections on the remote control panel so as to traverse through the menus on the front panel 102. Changes made through the remote control panel displayed on the remote user interface 104 are reflected in the front panel 102.

In one embodiment, the remote control panel is displayed as a web page in the web browser. The web page may be active Hypertext Markup Language (HTML) pages via Active Server Pages (ASP), Java Server Pages (JSP), Personal Home Page (PHP), or other technologies such that a user may interact with the remote control panel on the web page. Interaction, e.g., mouse clicks, on the active web page are relayed to the embedded web server which then maps the selections to appropriate device commands.

In the exemplary embodiment, the front panel 102 of the MFP 101 may be accessed by a user at the MFP and another user via the remote control panel simultaneously. Such simultaneous operation may be allowed or disallowed via an administrative setup, depending on the configuration and situation.

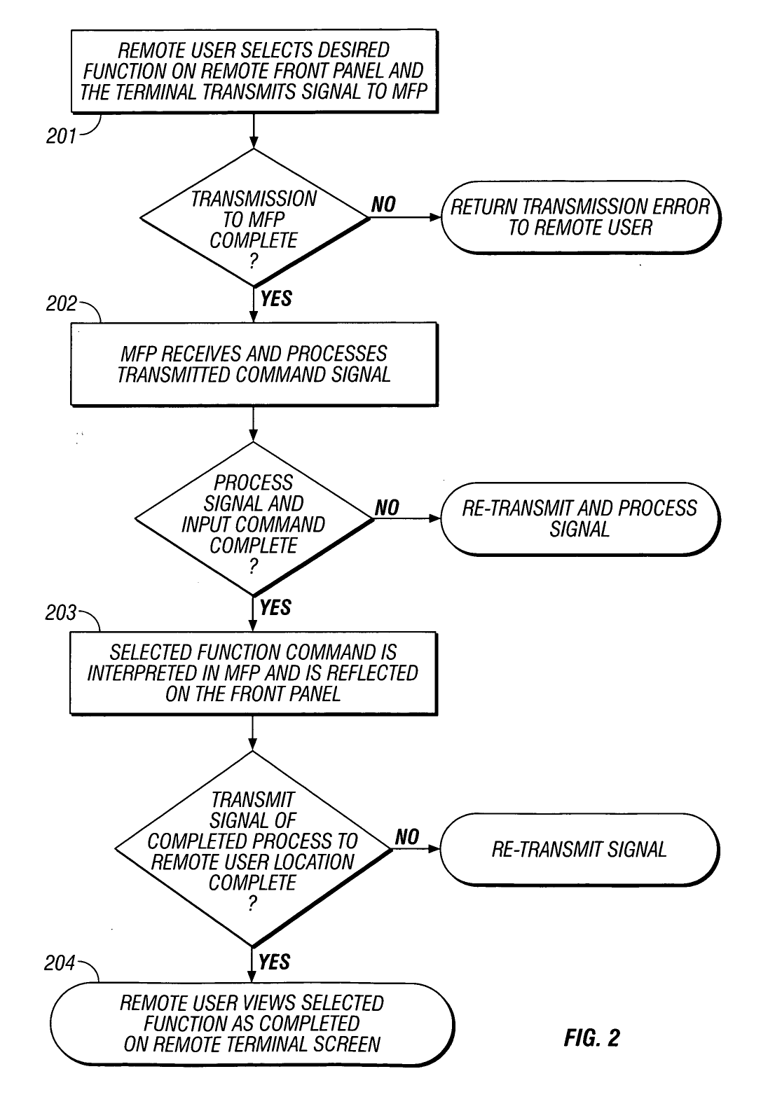

FIG. 2 is a flowchart of one embodiment of a method of remotely controlling the front panel of a MFP. The exemplary method may be performed on, for example, a system as described in FIG. 1. Depending on the embodiment, certain steps of the method may be removed, merged together, or rearranged in order. The general principle of the exemplary method will be described as below.

The method begins at a block 201, where a remote user selects a desired function on the remote control panel. In one embodiment, the remote control panel is an active web page such that the remote user may actively interact with the remote control panel. The desired function may be associated with a control (such as an icon or a menu item) in the remote control panel. The user may select the desired function by, for example, clicking the associated icon or menu item. Once a desired function is selected, the terminal, or the remote control interface 104, transmits a signal, typically in the form of a message or command, indicating the selected function to the MFP 101. If the transmission is not complete, a transmission error is sent to the remote user. If the transmission is complete, the method moves to a block 202.

Next at block 202, the MFP 101 receives and processes the transmitted command signal. In one embodiment, the transmitted command signal may be sent to the embedded web server, which then maps the signal to a selected function command of the MFP 101. For example, the mapping of the command signal may cause the execution of software that identifies a software function of the MFP. The selected function command is associated with a control on the front panel 102 corresponding to the selected control on the remote control panel. If the receiving and processing of the signal is not complete, the signal will be re-transmitted and processed. If the receiving and processing of the signal is complete, the method moves to a block 203.

At a block 203, the selected function command is interpreted and performed in the MFP 101. After the command is performed, the screen of the front panel 102 is updated accordingly to reflect any changes made. For example, if the user selects a menu item on the remote control panel, the display of the front panel 102 is updated to be the same as after a user selects the menu item on the front panel at the device. A signal indicating the new screen of the front panel is then sent back to the remote user. If the signal is not sent correctly, the signal will be re-sent. If the signal is sent correctly, the method then moves to a block 204.

Last at block 204, the remote user interface receives the signal indicating the new screen of the front panel 102 and changes the remote control panel to substantially match the new screen of the front panel. The remote user views, via the remote control panel, the display on the front panel as if the desired function is selected at the front panel.

As illustrated, this embodiment enables a remote user to control the front panel 102 via a remote user interface, just as if one is operating the front panel 102 at the device.

The general principle of the method as described above may be applied to various devices to perform various operations. In the following, one example will be used to illustrate how the method may be used to change an email setting. It will be appreciated that the method may be applied similarly to other types of functions provided by the front panel.

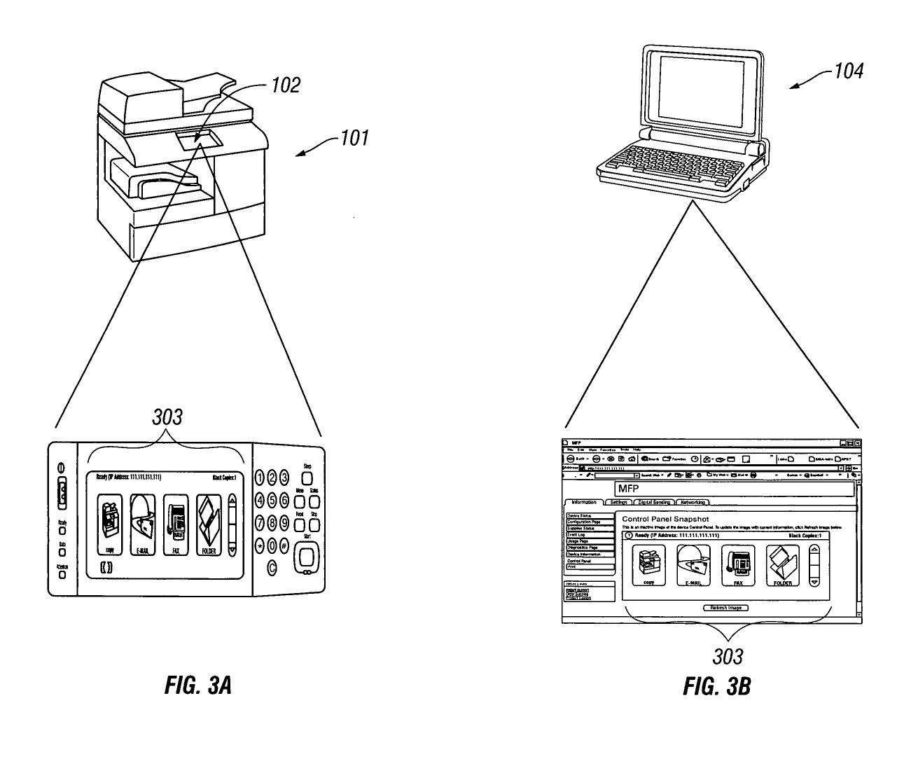

FIGS. 3A and 3B illustrate exemplary views of the front panel of a MFP as seen by the front panel user and as seen by the remote front panel user. The user interface 104 is connected to the MFP 101 via the embedded web server. As illustrated, substantially the same screen 303 is displayed both at the front panel 101 in FIG. 3A and at the remote control panel in a web page in FIG. 3B. In some embodiments, the display at the front panel and the remote control panel may not be exactly the same. In fact, the views could look very different because of, for example, differences in screen ratios and pixel resolutions. However, in any event, the front panel and the control panel generally provide access to substantially the same functionality.

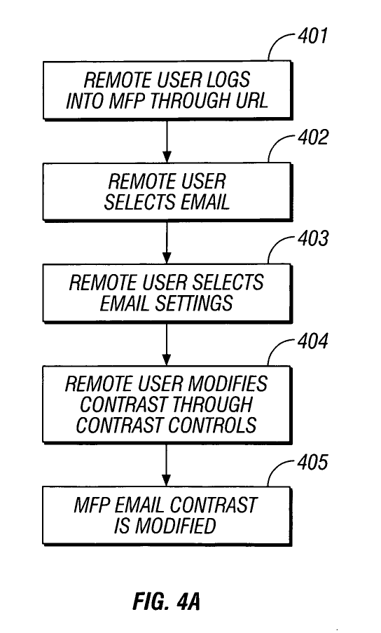

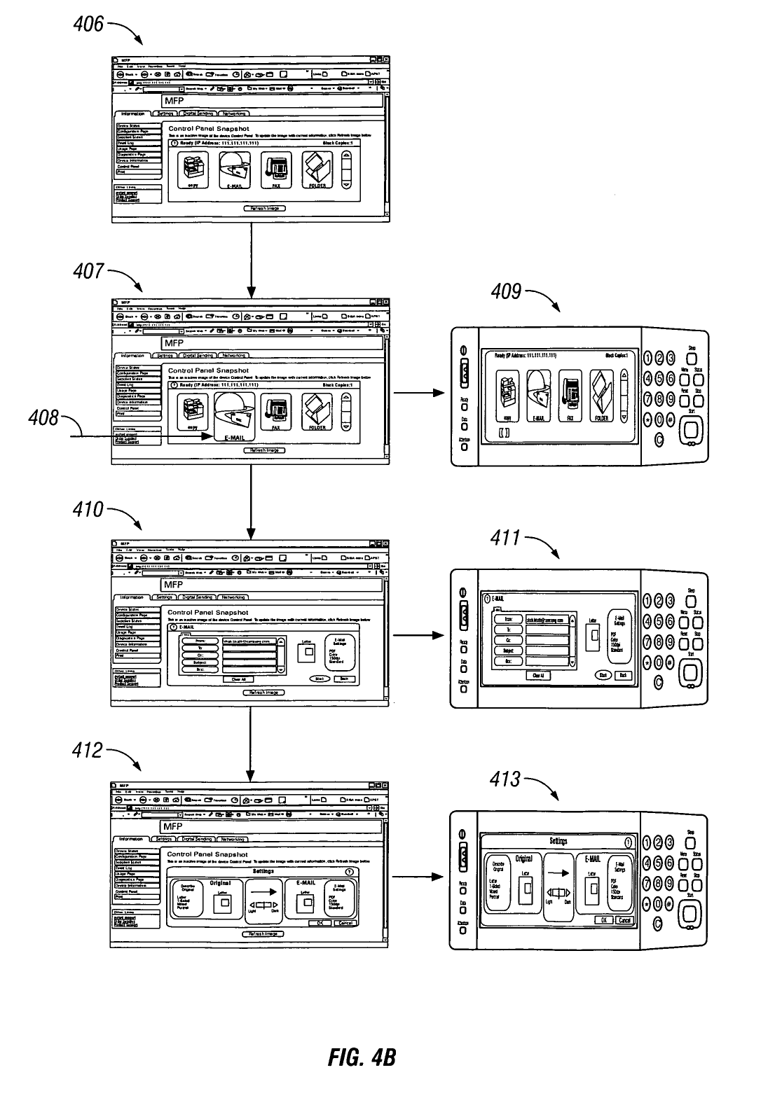

FIG. 4A is a flowchart of one exemplary method of remotely modifying the contrast of a MFP. FIG. 4B illustrates a series of exemplary screen shots as seen through the contrast modification in FIG. 4A. Depending on the embodiment, certain steps of the method may be removed, merged together, or rearranged in order. This exemplary method may be used to, for example, demonstrate a user how to darken the image settings on the device for email.

The method begins at a block 401, where the remote user logs into the embedded web server of the MFP by typing a uniform resource locator (URL) in the web browser. For example, the URL may be “http:/111.111.111.111” where 111.111.111.111 is the IP address of the device. Once connected, a web page 406 including a remote control panel is displayed to the remote user. The remote control panel shows four menu tabs: Copy, E-mail, Fax, and Folder.

Next at a block 402, the remote user selects one of the menu tabs, in this case, E-mail, by clicking on the tab. The screen 407 on the remote control panel shows that the E-mail menu tab 408 is highlighted, while a similar screen 409 is shown on the front panel.

After the selection, the remote control panel moves to a screen 410 which is associated with the menu tab E-mail in the front panel. The screen 410 is the same as what will be displayed at the front panel after a user clicks the menu tab E-mail on the front panel at the device. The screen 410 includes a menu tab E-mail Setting. The front panel also displays a screen 411 which is about the same as the screen 410.

Moving to a block 403, the remote user selects one of the menu tabs, E-mail Settings, by clicking on the tab. After the selection, the remote control panel moves to a screen 412 which is associated with the menu tab E-mail Settings in the front panel. The front panel also displays a screen 413 which is substantially the same as the remote screen 412. The screen 412 includes a contrast control, i.e., a slider to adjust the contrast.

Next at a block 404, the remote user modifies the contrast setting. The user may, for example, use a mouse to drag the slider across the screen. As the remote user moves the slider to the left or the right, the remote control panel simultaneously shows the changes made by the user.

Last at the block 405, the modification made by the user is saved to the MFP and also reflected in the front panel.

The foregoing description details certain embodiments of the invention. It will be appreciated, however, that no matter how detailed the foregoing appears in text, the invention may be practiced in many ways. It should be noted that the use of particular terminology when describing certain features or aspects of the invention should not be taken to imply that the terminology is being re-defined herein to be restricted to including any specific characteristics of the features or aspects of the invention with which that terminology is associated.

While the above detailed description has shown, described, and pointed out novel features of the invention as applied to various embodiments, it will be understood that various omissions, substitutions, and changes in the form and details of the device or process illustrated may be made by those skilled in the technology without departing from the spirit of the invention. The scope of the invention is indicated by the appended claims rather than by the foregoing description. All changes which come within the meaning and range of equivalency of the claims are to be embraced within their scope.

What is claimed is:

1. A system for remotely controlling a multi-function peripheral (MFP), comprising:
a MFP having a front panel and an embedded web server; and
a remote user interface;
wherein the remote user interface is remotely connected to the MFP by the embedded web server and permits modifications to the MFP via front panel commands.

2. The system of claim 1, wherein the MFP reflects modifications on the front panel made through the remote user interface in real-time.

3. The system of claim 1, wherein the user interface and the MFP utilize active Hypertext Markup Language (HTML) pages via Active Server Pages (ASP).

4. The system of claim 1, wherein the user interface and the MFP utilize active HTML pages via Java Server Pages (JSP).

5. The system of claim 1, wherein the user interface and the MFP utilize active HTML pages via Personal Home Page (PHP).

6. A method of remotely controlling a multi-function peripheral (MFP) having a front panel, comprising:
remotely logging onto the MFP through a Uniform Resource Locator (URL);
traversing the front panel of the MFP through the URL; and
actively selecting different functions of the MFP;
wherein the functions are associated with the front panel controls of the MFP.

7. The method of claim 6, wherein changes made on the front panel replicated on the web browser reflects changes made by the user on the front panel of the MFP.

8. The method of claim 6, wherein the MFP is configured to permit blocking the remote control by users through the URL.

9. The method of claim 6, wherein the user remotely controlling the MFP has the option to block the control of the front panel by users.

10. The method of claim 6, further comprising providing remote support of the MFP.

11. The method of claim 6, further comprising remotely monitoring the MFP.

12. The method of claim 6, further comprising remotely configuring the MFP.

13. The method of claim 6, further comprising remotely running diagnostics on the MFP.

14. The method of claim 6, wherein the MFP includes one or more of the following functions: printer, fax machine, copier, and scanner.

15. A multi-function peripheral (MFP) containing an embedded web server, wherein the embedded web server establishes a connection with a remote web server, providing simultaneous functionality of front panel controls of the device through both input locations.

16. A multi-function peripheral (MFP) system for transmitting a signal to a remote location, comprising:
means for remotely logging onto the MFP;
means for traversing the front panel of the MFP from the remote location; and
means for actively selecting different functions of the MFP from the remote location.

17. The MFP system of claim 16, further comprising means for transmitting a signal to a remote location via the World Wide Web (WWW).

18. The MFP system of claim 16, wherein the means for remotely logging onto the MFP is through a Uniform Resource Locator (URL).

19. The MFP system of claim 18, wherein the means for traversing the front panel of the MFP is through a URL.

20. The MFP system of claim 16, wherein the functions are associated with the front panel controls of the MFP.

21. A multi-function device (MFP) system having a front panel and capable of transmitting and receiving signals to and from a remote location via the World Wide Web, comprising:
means for remotely logging onto the MFP through a Uniform Resource Locator (URL);
means for traversing the front panel of the device through a URL from a remote location; and
means for actively selecting different functions of the MFP from a remote location;
wherein the functions are associated with the front panel controls.
